(19) United States
(12) Patent Application Publication
(10) Pub. No.: US 2006/0055170 A1
(43) Pub. Date: Mar. 16, 2006

(54) Film-type object having an extensive forgery-proof nature

(76) Inventor: Markus Luthi, Marthalen (CH)

Correspondence Address: FISHER, CHRISTEN & SABOL, 1725 K STREET, N.W., SUITE 1108, WASHINGTON, DC, 20006, US

(21) Appl. No.: 10/527,159

(22) PCT Filed: Oct. 1, 2003
(86) PCT No.: PCT/CH03/00655

§ 371 Date: Mar. 9, 2005

(30) Foreign Application Priority Data
Oct. 10, 2002 (EP) 02405873.7

(51) Int. Cl. B42D 15/00

(52) U.S. Cl. 283/113

(57) ABSTRACT

A film-type object having partial images that are arranged on both sides of the object, and complete each other in the transmitted light by superimposition to form a predefined image with an extensive forgery-proof nature. In order to increase the forgery-proof characteristic, a first surface region in the form of a first image pattern is arranged on one side of the object, and a second surface region in the form of a second image pattern is arranged on the second side of the object. The two image patterns are formed from the same number and shape of light and dark image elements that are randomly arranged over the entire surface. The two image patterns are divided into a basic region with an identical arrangement of image elements, and a selection region with a predefined, non-identical arrangement of image elements. The two image patterns superimpose each other in a congruent manner in the transmitted light, and produce the predefined image in the selection region.

The invention relates to a film-shaped object with partial images arranged on either side and becoming complete in transmitted light by overlaying to form a predefined image.

The security of packagings against forgery is of great significance primarily for the pharmaceutical industry. However, the desire also exists in other sectors for packagings or products which are secure against forgery, in particular iri the consumer goods industry, for example in the packaging of foods, cosmetic articles, clothes, software and music CDs. A further area of application relates to documents which are secure against forgery, such as banknotes and securities.

The film-shaped object with the image which is secure against forgery may be a packaging, a packing material, a packing aid, a security part designed, for example, as a label or a product itself.

A packaging which is secure against forgery or a packing aid may serve as a guarantee of originality which allows the customer to recognise that the product acquired by him is actually produced and packaged by the desired producer. A packing aid which is secure against forgery may inter alia also be used as a guarantee of first opening, for example in the form of a label, a tape or a sealing strip etc., which are fixed, for example, over a bottle seal or over the seal of a wide-mouth jar, over the seam between a lid and a container or over the tear-off closure of a bag. On opening the corresponding packaging, the label, the tape or the sealing strip is destroyed and it is thereby shown that a first opening has taken place already. It is also possible to fill or wrap objects in an outer packaging, the outer packaging having characteristic, irreplaceable features which are difficult to copy, which show that the contents has been packaged by a specific supplier.

Known packagings and products which are secure against forgery are provided with holograms on their surface or have colour codings or invisible features. Holograms inter alia have been successful in practice in achieving a high degree of security against forgery. Examples are hologram labels or lid films with integrated holograms. However, the production of holograms is connected with an enormous outlay.

An object with a surface area producing an optical effect to increase the security against forgery is known from WO-A-00 00356. The surface area with the optical effect has at least two image patterns held at a fixed spacing by a transparent material layer, and the optical perception of the overall image produced by the overlaying of the image pattern changes when the observation angle is changed. The spacing between the image patterns defined by the thickness of the transparent material layer and the distance between adjacent image elements on which the image patterns are based are matched to each other here such that the image patterns show Moiré interferences.

EP-A-0 260 815 and U.S. Pat. No. 5,488,664 disclose an object with a first image pattern with a high degree of security against forgery and a checking film to be used with the object and made of a transparent material with a second image pattern for the recognition of a forged image pattern. The two image patterns are constructed, to substantially cover the area, from randomly arranged, light and dark image elements of the same number and with the same form and are divided into a base area with an identical arrangement of the image elements and a selection area with predefined, non-identical arrangement of the image elements. When there is a congruent overlay of the two image patterns by exact positioning of the image pattern of the checking film over the image pattern of the object, a predefined image is produced when there is a non-forged image pattern in the selection area. As, on the one hand, a high degree of security against forgery requires high print quality and fineness of print or a high resolution but, on the other hand, the exact positioning of the image pattern with an increasing fineness of print or with a higher resolution becomes more difficult, there are limitations in practice on objects of this type which are secured against forgery.

A security element which is known in banknotes is the division of a number into, for example, six parts, with three respective parts being printed on the front and on the back of the banknote in such a way that the number can be seen as a whole when observed in transmitted light. The security against forgery is produced from the difficulty of exact printing of the front and back which requires an extremely precise register print.

The invention is based on the object of further increasing the security against forgery in a film-shaped object of the type mentioned at the outset. In addition, the object should be able to be checked for authenticity in a simple manner.

Leading to the solution of the object according to the invention is the fact that, to increase security against forgery, a first surface area in the form of a first image pattern is arranged on one side of the object and a second surface area in the form of a second image pattern is arranged on the second side of the object, the two image patterns being constructed to substantially cover the area from light and dark image elements of the same number and the same form arranged randomly, the two image patterns being divided into a base area with an identical arrangement of the image elements and a selection area with a predefined, non-identical arrangement of the image elements, the two image patterns lying congruently one above the other in the transmitted light and generating the predefined image in the selection area.

A substantial prerequisite for achieving a high degree of security against forgery is, of course, a high print quality and fineness of print or a high print resolution. Together with an extremely precise register print, a much higher degree of security against forgery can be achieved by the object according to the invention in comparison to the objects with a checking film known from the prior art.

In a preferred embodiment of the film-shaped object, two, four or six respective image elements form image element cells which have a rotational symmetry with an angle of rotation of 180°, 90° or 60°, the light and the dark image elements being arranged rotationally symmetrically in one image element cell and so as to alternate in the direction of rotation, the image elements being arranged randomly in the image patterns with respect to their angular position, and the two image patterns being divided into a base area with an identical arrangement of the image element cells and into a selection area with a non-identical arrangement of the image elements, which is predefined with respect to their angular position.

The light image elements may, for example, be white and the dark image elements black. However, they may be constructed from the same or different colours. A further possibility is for the image elements to have a colour which is only visible in UV or infrared light and therefore to only be visible in UV or infrared light.

Image patterns are preferably printed onto the object, the image patterns for congruent overlaying expediently being applied to the object by means of registered print. The printing of the film-shaped object takes place with known printing methods. Instead of conventional printing methods, other techniques can obviously be used, such as, for example, the laser coding methods for producing the image patterns.

The predefined image produced by the image patterns in the selection area may be, for example, a water mark, a number, a sign, a script, a logo or a continuous tone image, this list not being conclusive.

A preferred area of application of the film-shaped object according to the invention is in its use in the form of a packaging, a packing material, a packing aid, a security, a banknote, an entry ticket or similar documents with a high degree of security against forgery.

The film-shaped object according to the invention may, for example, be any packaging material in the form of a packing material or a packing aid, the image patterns according to the invention also being applied to the two sides. Examples of film-shaped materials are papers and plastics material-containing films, for example based on polyolefins, such as polyethylenes or polypropylenes, polyamides, polyvinyl chloride, polyesters, polyalkylene terephthalates and in particular polyethylene terephthalate. The plastics material-containing films may be monofilms made of plastics materials, laminates made of two or more plastics material films, laminates made of papers and plastics materials. The individual layers of the film-shaped materials can be fixed to one another by means of glues, laminating glues, bonding agents and/or by extrusion coating, coextrusion or laminating. Preferred plastics material films are non-oriented or axially or biaxially oriented monofilms or laminates made of two or more non-oriented or axially or biaxially oriented films made of plastics materials based on polyolefins, such as polyethylenes or polypropylenes, polyamides, polyvinyl chloride, polyesters, such as polyalkylene terephthalates and in particular polyethylene terephthalate.

The packaging materials mentioned above may form the objects according to the invention in the form of packing materials or packing aids. For example, bags, sachets, wrappers, pockets etc. can be produced from film-shaped packing materials by punching and sealing. Closures, openings, seams between a base part and the associated lid etc. can be provided with the object according to the invention as a packing aid in the form of a label, a sealing strip, a tape, a seal of guarantee or an outer closing. These last-mentioned packing aids are generally present in film-form and are fixed, such as for example firmly glued, welded, crimped or shrunk on the corresponding container over the opening and on the adjacent container part.

As already mentioned, apart from the use of the film-shaped object according to the invention in the form of a packaging, a packing material or a packing aid, a further area of application is the production of securities, bank notes, entry tickets and documents of the type with a high degree of security against forgery.

Further advantages, features and details of the invention emerge from the following description of preferred embodiments and with the aid of the drawings, in which, schematically,

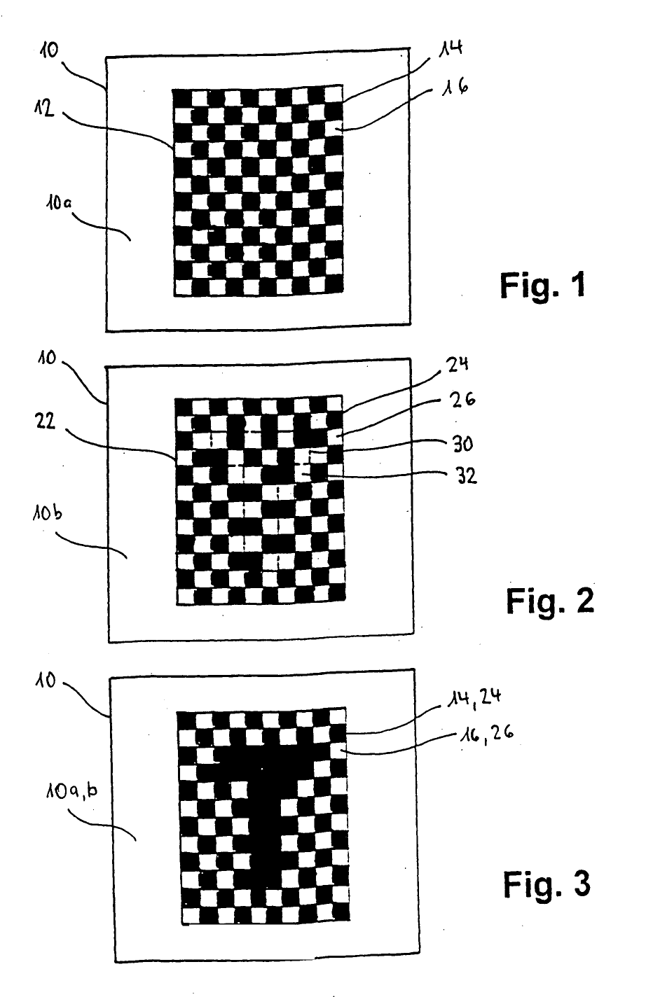

FIG. 1 shows a first side of a film-shaped object with a first surface area in the form of a first image pattern;

FIG. 2 shows the back of the film-shaped object of FIG. 1 with a second surface area in the form of a second image pattern;

FIG. 3 shows the subject of FIG. 1 with overlaying of the two surface areas with the image patterns congruently applied in the transmitted light,

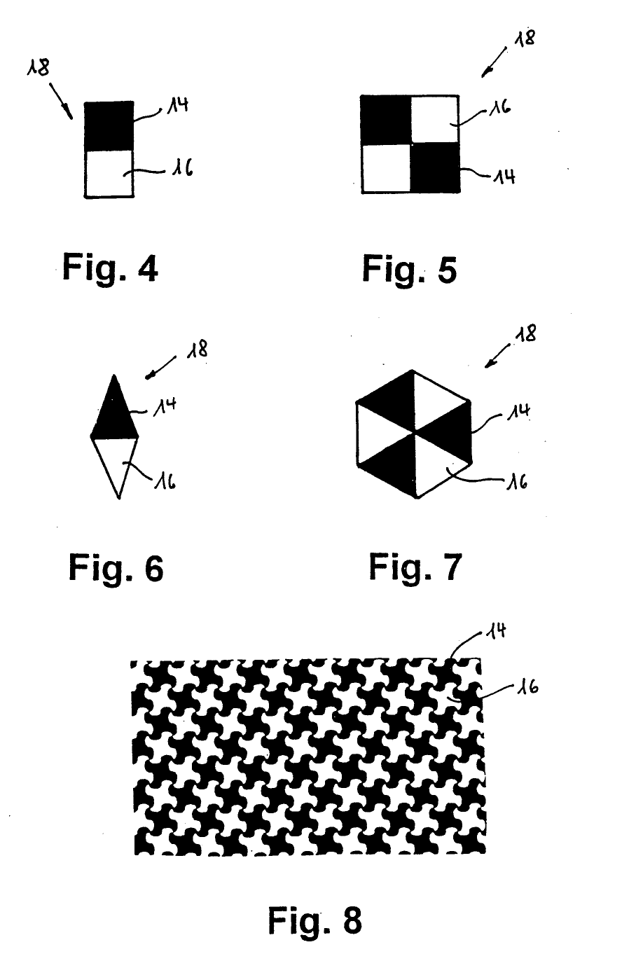

FIGS. 4 to 8 show examples of image element cells.

The film-shaped object 10 shown in FIG. 1 is, for example, a packaging film and on one side 10a, for example on the front, has a first surface area in the form of a first image pattern 12. The first image pattern 12 has a gridline pattern which divides the surface area, covering the area, into a large number of square image elements 14, 16. 50% each of black image elements 14 and white image elements 16 are regularly arranged for simplicity in the drawing. According to the invention, in the present case, a respective black and white image element 14,16, with a rotational symmetry with an angle of rotation of 180° or two black and two white image elements 14, 16 with a rotational symmetry with an angle of rotation of 90° form an image element cell 18, the image element cells 18 being randomly arranged with respect to their angular position. The black image elements 14 are printed, for example, on the film surface, the white image elements 16 show the unprinted film.

The back 10b of the film-shaped object 10 shown in FIG. 2 has a second surface area with a second image pattern 22. The second image pattern 22 is, like the first image pattern 12, a gridline pattern, which divides the second surface area, covering the area, into a large number of square image elements 24, 26. The gridline pattern of the first image pattern 12 and the second image pattern 22 have identical dimensions. In the present case, one black and one white image element 24, 26, in each case with a rotational symmetry with an angle of rotation of 180°, or two black and two white image elements 24, 26 with a rotational symmetry with an angle of rotation of 90°, form an image element cell 28, the image element cells 28 being randomly arranged with respect to their angular position.

The second surface area with the second image pattern 22 comprises a selection area 30, which corresponds in the example shown to the face of a letter T. The face of the second image pattern 22 outside this selection area 30 is denoted the base area 32.

The second image pattern 22 on the rear 10b differs from the first image pattern 12 on the front of the film-shaped object 10 in that in the selection area 30, a white image element 26 of the second image pattern 22 corresponds to each black image element 14 of the first image pattern 12 and a black image element 24 of the second image pattern 22 corresponds to each white image element 16 of the first image pattern 12.

The black image elements 24 are printed, for example, on the back 10b and the white image elements 26 are unprinted.

In the congruent overlay, which can be seen in the transmitted light and shown in FIG. 3, of the second surface area with the second image pattern 22 on the back 10b and of the first surface area with the first image pattern 12 on the front 10a of the film-shaped object 10, the black image elements 16 of the first image pattern 12 and the black image elements 24 of the second image pattern 22 become complete to form a completely black face within the selection area 30, so the letter T can clearly be seen.

Examples of image elements 14, 16 and image element cells 18 are reproduced in FIGS. 4 to 8.

The arrangement shown in FIG. 4 corresponds to the example shown in FIGS. 1 to 3. The individual image elements 14, 16 are squares, a black image element 14 and an adjacent white image element 16 forming a rectangular image element cell 18. The angle of rotation here is 180°.

In the example shown in FIG. 5, four respective square image elements 14, 16. are combined to form an image element cell 18. The angle of rotation here is 90°.

In the example shown in FIG. 6, the individual image elements 14, 16 are isosceles, non-equilateral triangles, two adjacent image elements forming a rhombic image element cell 18. The angle of rotation between the image element cells of the first and second image pattern here is 180°.

In the example shown in FIG. 7, the individual image elements 14, 16 are equilateral triangles and the image element cells 18 form a hexagon. The angle of rotation for the image element cells 18 here is 60°.

FIG. 8 shows an image pattern 12 with an area-covering arrangement of black and white image elements 14, 16. Two or four image elements 14, 16, in each case form image element cells 18 with a rotational symmetry with an angle of rotation of 180° or 90°.

1. A film-shaped object comprising partial images arranged on either side and becoming complete in transmitted light by overlaying to form a predefined image with a high degree of security against forgery, where, in order to increase the degree of security against forgery, a first surface area in the form of a first image pattern (12) is arranged on one side (10a) of the object (10) and a second surface area in the form of a second image pattern (22) is arranged on the second side (10b) of the object (10), the two image patterns (12, 22) being constructed, to * substantially cover the area, from light and dark image elements (14,16; 24, 26) of the same number and the same form arranged randomly, the two image patterns (12, 22) being divided into a base area (32) with an identical arrangement of the image elements (14,16; 24, 26) and selection area (30) with a predefined, non-identical arrangement of the image elements (14, 16; 24, 26), the two image patterns (12, 22) lying congruently one above the other in the transmitted light and generating the predefined image in the selection area (30).

2. A film-shaped object according to claim 1, wherein two, four or six image elements (14, 16; 24, 26) in each case form image element cells (18, 28), which have a rotational symmetry with an angle of rotation of 180°, 90° or 60°, the light and the dark image elements (14, 16; 24, 26) being arranged rotationally symmetrically in one image element cell (18, 28) and so as to alternate in the direction of rotation, the image elements (18, 28) being arranged randomly in the image patterns (12, 22) with respect to their angular position, and the two image patterns (12, 22) being divided into a base area (32) with an identical arrangement of the image element cells (18, 28) and into a selection area (30) with a non-identical arrangement of the image element cells (18, 28), which is predefined with respect to their angular position.

3. The film-shaped object according to claim 2, wherein the light image elements (16, 26) are white and the dark image elements (14, 24) are black.

4. The film-shaped object according to claim 3, wherein the image elements (16, 18; 26, 28) are constructed from the same or different colors.

5. The film-shaped object according to claim 4, wherein at least some of the image elements (14, 16; 24, 26) have a first color which is only visible in UV or in infrared light, and are only visible in ultraviolet or infrared light.

6. The film-shaped object according to claim 5, wherein the image patterns (12, 22) are printed on the object (10).

7. The film-shaped object according to claim 6, wherein the predefined image which is generated by the image patterns (12, 22) in the selection area (30) is a water mark, a number, a sign, a script, a logo or a continuous tone image.

8. The film shaped object according to claim 7, wherein the image patterns (12, 22) for the congruent overlay are applied by means of register print to the object (10).

9. A process comprising utilizing a film-shaped object according to claim 7, in the form of a packaging, a packing material, a packing aid, a security, a banknote, an entry ticket or similar documents with a high degree of security against forgery.

10. The film-shaped object according to claim 1, wherein the light image elements (16, 26) are white and the dark image elements (14, 24) are black.

11. The film-shaped object according to claim 1, wherein the light image elements (16,18; 26, 28) are constructed from the same or different colors.

12. The film-shaped object according to claim 1, wherein at least some of the image elements (14, 16; 24, 28) have a first color which is only visible in UV or in infrared light, and are only visible in ultraviolet or infrared light.

13. The film-shaped object according to claim 1, wherein the light patterns (12, 22) are printed on the object (10).

14. The film-shaped object according to claim 1, wherein the predefined image patterns which is generated by the image patterns (12, 22) in the selection area (30) is a water mark, a number, a sign, a script, a logo or a continuous tone image.

15. The film-shaped object according to claim 1, wherein the the image patterns (12, 22) for the congruent overlay are applied by means of register print to the object (10).

16. A process comprising utilizing the film-shaped object according to claim 1, in the form of a packaging, a packing material, a packing aid, a security, a banknote, an entry ticket or similar documents with a high degree of security against forgery.
